(19) United States
(12) Patent Application Publication
(10) Pub. No.: US 2014/0156803 A1
(43) Pub. Date: Jun. 5, 2014

(54) TRANSACTION SYSTEM FOR EXCHANGING COMMODITY DATA VIA PORTABLE STORAGE DEVICE AND METHOD THEREOF

(71) Applicants: INVENTEC (PUDONG) TECHNOLOGY CORPORATION, Shanghai (CN); INVENTEC CORPORATION, Taipei (TW)

(72) Inventor: Chaucer Chiu, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/795,358

(22) Filed: Mar. 12, 2013

(30) Foreign Application Priority Data
Nov. 30, 2012 (CN) 201210507863.9

(51) Int. Cl. H04L 29/08

(52) U.S. Cl. CPC H04L 67/104
USPC 709/219

(57) ABSTRACT

A transaction system for exchanging commodity data via a portable storage device and a method thereof are provided. Commodity content of a candidate commodity sold on a server is stored in the portable storage device, commodity identification data of the candidate commodity selected by a user is stored after the user uses an operating device to select the candidate commodity stored in the storage device, and the server generates transaction result information according to the commodity identification data stored in the storage device. By using the technical means, the transaction system and the method thereof can prevent a network transaction platform from affecting consumption due to management conditions, and achieve the technical efficacy of effectively providing a commodity to a specific group merely.

### BACKGROUND OF THE INVENTION

1. Field of the Invention

The present invention relates to a transaction system and a method thereof, and particularly to a transaction system for exchanging commodity data via a portable storage device and a method thereof.

2. Description of Related Art

With rapid development of electronic commerce and network economy, in addition to obtaining required information from Internet, more and more users obtain a variety of information, services, and products through a variety of network transaction, and the variety of information, services, and products are implemented through an idea, an architecture, and a technology of cloud computing.

The point-to-point real-time network transaction is a main transaction manner of electronic commerce currently. On a network transaction platform, a client makes a transaction request to a server, and the server performs a transaction operation according to a commodity selected by the client. Therefore, whether the network between the client and the server is normally operated is one of the key factors ensuring success of the transaction. When software and hardware of the client or the server do not operate normally or the network connection is interrupted, the transaction fails. When the problem resulting in a transaction failure occurs on the server, a consumer is likely to lose purchase intentions, so that business opportunities are lost.

Furthermore, information on the network transaction platform is open, and every one can connect to the server through the network and browse commodities sold on the server. When a seller of some commodities only hopes that the sold commodities are browsed by a specific group, the seller can only set browsing authorities to the commodities to restrict a user who does not belong to the specific group from browsing the commodities. However, the server is usually open to users for unlimited registration. Therefore, even though a new registered consumer belongs to the specific group, the user still cannot purchase the commodities as long as the user is not set to be able to browse the commodities, so that business opportunities are lost.

To sum up, it can be known that the prior art has the problem that consumption of a user of the open network transaction platform is affected due to conditions of software and hardware management in a long term; therefore, it is necessary to put forward an improved technical means to solve the problem.

### SUMMARY OF THE INVENTION

In view of the problem in the prior art that consumption of a user of a network transaction platform may be affected due to conditions of software and hardware management, the present invention discloses a transaction system for exchanging commodity data via a portable storage device and a method thereof.

The transaction system for exchanging commodity data via a portable storage device disclosed by the present invention at least includes: a storage device, used for storing a commodity data set, where the commodity data set includes a candidate commodity, and the candidate commodity is corresponding to commodity identification data; an operating device, used for displaying the candidate commodity, and selecting the candidate commodity when the operating device is connected to the storage device, so that the storage device records the commodity identification data corresponding to each selected candidate commodity; and a server, used for generating transaction result information according to the commodity identification data recorded by the storage device, when the server is connected to the storage device.

The transaction method for exchanging commodity data via a portable storage device disclosed in the present invention at least includes: connecting a storage device to a server; transmitting a commodity data set by the server to the storage device for storage; connecting the storage device to an operating device; displaying commodity content of a candidate commodity included in the commodity data set by the operating device, and selecting the candidate commodity, where the selected candidate commodity is corresponding to commodity identification data; reconnecting the server to the storage device; obtaining the commodity identification data recorded by the storage device by the server; and generating transaction result information by the server according to the recorded commodity identification data.

The system and the method disclosed in the present invention are described as above, and the difference between the present invention and the prior art lies in that in the present invention, commodity content of a candidate commodity sold on a server is stored in a portable storage device, commodity identification data of the candidate commodity selected by a user is stored after the user uses an operating device to select the candidate commodity stored in the storage device, and the server generates transaction result information according to the commodity identification data stored in the storage device, so as to solve the problem in the prior art and achieve the technical efficacy of effectively providing a commodity to a specific group merely.

### BRIEF DESCRIPTION OF THE DRAWINGS

FIG. 1 is an architecture view of a transaction system for exchanging commodity data via a portable storage device according to the present invention.

FIG. 2A is a flowchart of a transaction method for exchanging commodity data via a portable storage device according to the present invention.

FIG. 2B is a flowchart of another transaction method for exchanging commodity data via a portable storage device according to the present invention.

FIG. 2C is a flowchart of an additional method for generating order content according to the present invention.

### DESCRIPTION OF THE EMBODIMENTS

Features and implementation manners of the present invention are illustrated in detail below with reference to accompanying drawings and embodiments, so that persons skilled in the art may easily and fully understand technical means used for solving the technical problem in the present invention and implement the technical means accordingly, so as to achieve efficacies of the present invention.

In the present invention, by using a storage device carried by a user, data may be transmitted between a server and an operating device which cannot be connected, so that the user may select a candidate commodity sold on the server through the operating device, and the server may generate transaction result information according to the candidate commodity selected by the operating device.

The transaction result information in the present invention is generated to record a candidate commodity, the number, the amount of money in the transaction, and other data related to transaction, for example, order information, but the present invention is not limited thereto. Generally, the transaction result information is displayed in a form of text, but the present invention is not specifically limited thereto, for example, the transaction result information may also include a picture of the candidate commodity.

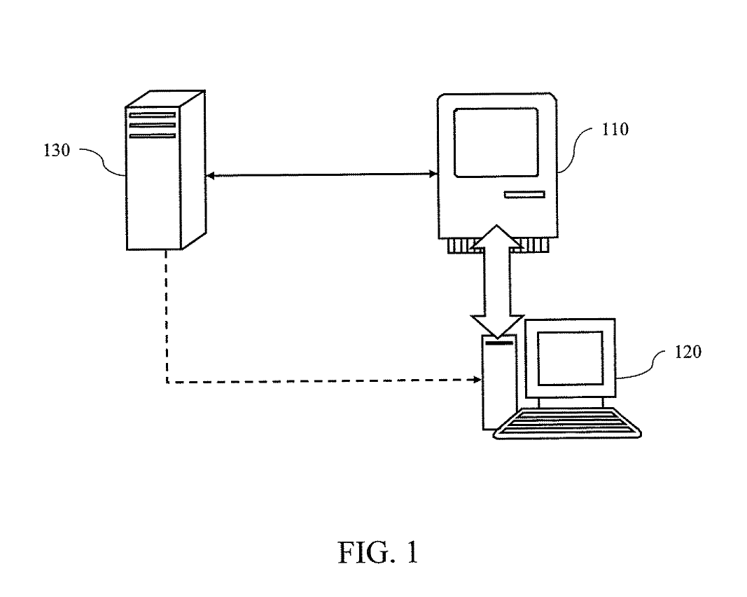

System operation of the present invention is described first in the following through a system architecture view of a transaction system for exchanging commodity data via a portable storage device according to the present invention shown in FIG. 1. As shown in FIG. 1, the system of the present invention includes a storage device 110, an operating device 120, and a server 130. A distance exists between the operating device 120 and the server 130 in geographic location, but the present invention is not specifically limited thereto.

The storage device 110 is a device of storage medium which can store any data, including but not limited to a flash disk, a mobile phone, a personal digital assistant (PDA), and a tablet computer.

The storage device 110 may be connected to the operating device 120 and the server 130 respectively in different time. Generally, since the distance exists between the operating device 120 and the server 130 in geographic location, the storage device 110 cannot be connected to the operating device 120 and the server 130 simultaneously.

When the storage device 110 includes a wireless communication module, such as Wireless Fidelity (Wi-Fi) or 3G, the storage device 110 may be connected to the operating device 120 or the server 130 through a wireless technology corresponding to the wireless communication module. When the storage device 110 merely includes a physical connection interface such as a universal serial bus (USS) or Institute of Electrical & Electronic Engineers (IEEE) 1394 interface, the storage device 110 needs to be connected, through a connecting line, to the operating device 120 or the server 130, or needs be inserted into a slot of the operating device 120 or the server 130.

The storage device 110 is responsible for storing a commodity data set transmitted by the server 130. The commodity data set stored in the storage device 110 includes commodity content of one or more candidate commodities, where each candidate commodity is corresponding to a commodity identification data, and the commodity identification data and the candidate commodity are in one-to-one or multiple-to-one correspondence. Generally, the commodity content of the candidate commodity includes corresponding commodity identification data, but the present invention is not limited thereto. In some embodiments, the candidate commodity is associated with a location where the server 130 is set. For example, when the server 130 is set in a hospital, the candidate commodity is a medical device, and when the server 130 is set in a school, the candidate commodity is exam data.

The commodity content of the candidate commodity in the present invention may be data presented in one or more forms such as text, a picture, a sound, and an image, but the presentation form of the commodity content of the candidate commodity is not limited thereto. Any data which enables the user to learn about the candidate commodity and makes the user determine whether to purchase the candidate commodity according to will of the user is the commodity content of the candidate commodity in the present invention, for example, an advertisement of the candidate commodity.

In some embodiments, the storage device 110 may be also responsible for storing personal data. The personal data stored in the storage device 110 at least includes personal identification data, where the personal identification data is data such as a mobile phone number, an identity card number, a user account, and a user fingerprint, but the present invention is not limited thereto, and any data which can be used to identify a specific user may be the personal identification data in the present invention. In addition, the personal data may also include basic personal data of the user such as a name, an address, and a contact manner.

In some embodiments, the storage device 110 may also store order content transmitted by the server 130. The order content in the present invention includes order data, that is, data such as a candidate commodity, the number, and a transaction amount of money in the transaction. The order content may also include additional data related to the transaction, for example, attentions and payment terms of this transaction and special offers of another candidate commodity, but the present invention is not limited thereto.

The operating device 120 can be connected to the storage device 110. Generally, the operating device 120 actively searches for the storage device 110, and when finding the storage device 110, establishes a connection with the storage device 110. But the present invention is not specially limited thereto, that is, the storage device 110 may also actively establish a connection with the operating device 120.

After establishing a connection with the storage device 110, the operating device 120 is responsible for obtaining a commodity data set recorded by the storage device 110, and displaying commodity content of the candidate commodity in the commodity content set to the user. When the operating device 120 is connected to the storage device 110 through the wireless technology or the wired network, the operating device 120 actively downloads or passively receives the commodity data set stored in the storage device 110. When the operating device 120 is connected to the storage device 110 through the connection line or the slot, the operating device 120 can directly read the commodity data set in the storage device 110. Generally, the operating device 120 actively obtains the commodity data set in the storage device 110, but the present invention is not specifically limited thereto.

The operating device 120 is also responsible for providing the user with an operating interface through which the user selects one or more candidate commodities whose commodity content is displayed, and the operating device 120 selects, according to the operation of the user, the candidate commodity selected by the user. Generally, the operating device 120 can store the commodity identification data of the candidate commodity selected by the user in the storage device 110 to complete selection of the commodity identification data. However, the mode of the operating device 120 selecting the commodity identification data is not limited thereto, for example, the operating device 120 can also write a specific mark at a specific location of the commodity content of the selected candidate commodity to select the candidate commodity. When the operating device 120 is connected to the storage device 110 through the wireless technology or the wired network, the operating device 120 transmits the commodity identification data of the selected candidate commodity to the storage device 110 for storage, or transmits the commodity data with the written specific mark back to the storage device 110 for storage. When the operating device 120 is connected to the storage device 110 through the connection line or the slot, the operating device 120 can directly open a file in the storage device 110 and write the commodity identification data of the selected candidate commodity, or open the commodity data set and write the specific mark at the specific location of the commodity content of the selected candidate commodity.

The server 130 can be connected to the storage device 110. The server 130 actively searches for the storage device 110, and when finding the storage device 110, establishes a connection with the storage device 110.

When being connected to the storage device 110, the server 130 is responsible for obtaining the commodity identification data of the selected candidate commodity recorded by the storage device 110. When the server 130 is connected to the storage device 110 through the wireless technology or the wired network, the server 130 actively downloads a file recording the commodity identification data of the selected candidate commodity or downloads the commodity data set, so as to read the commodity identification data of the selected candidate commodity. When the server 130 is connected to the storage device 110 through the connection line or the slot, the server 130 can directly read the file which records the commodity identification data or the commodity data set stored in the storage device 110, so as to read the commodity identification data of the selected candidate commodity. Generally, the server 130 actively downloads or reads the commodity identification data recorded by the storage device 110, but the present invention is not specifically limited thereto.

After obtaining the commodity identification data recorded by the storage device 110, the server 130 is also responsible for generating transaction result information according to the obtained commodity identification data. In some embodiments, after generating the transaction result information, the server 130 can further generate order content corresponding to the transaction result information, transmit the generated order content to the storage device 110 for storage, and/or transmit, through the network, the generated order content to the operating device 120. Even, after generating the transaction result information, the server 130 can also transmit the generated transaction result information to an external transaction system, so that the user can directly set a site of the server 130 for payment and take the selected candidate commodity, so as to complete the transaction.

When being connected to the storage device 110, the server 130 can also obtain personal data of the user, in addition to obtaining the commodity identification data recorded by the storage device 110. When obtaining the personal data, the server 130 generates the transaction result information according to the obtained commodity identification data and the obtained the personal data.

In addition, when the sever 130 is connected to the storage device 110 each time, the server 130 may also judge whether a version or content of the commodity data set stored in the storage device 110 is the same as those of the commodity data set stored in the server 130. If not, the server 130 uploads and updates the commodity data set stored in the storage device 110.

In some embodiments, after establishing a connection with the storage device 110 and before transmitting the commodity data set to the storage device 110, the server 130 may further identify that the storage device 110 is corresponding to information of a specific site set in advance by the server 130. If not, the server 130 does not transmit the commodity data set to the storage device 110; if yes, the server 130 transmits the commodity data set to the storage device 110, so as to the provide the commodity data to the user of the specific group. The site information corresponding to the storage device 110 includes the following: a location of the storage device 110 falls within a preset geographic range, a network address used by the storage device 110 falls within a preset network segment, or the storage device 110 is connected, through a preset relay device, to the server 130, and the like.

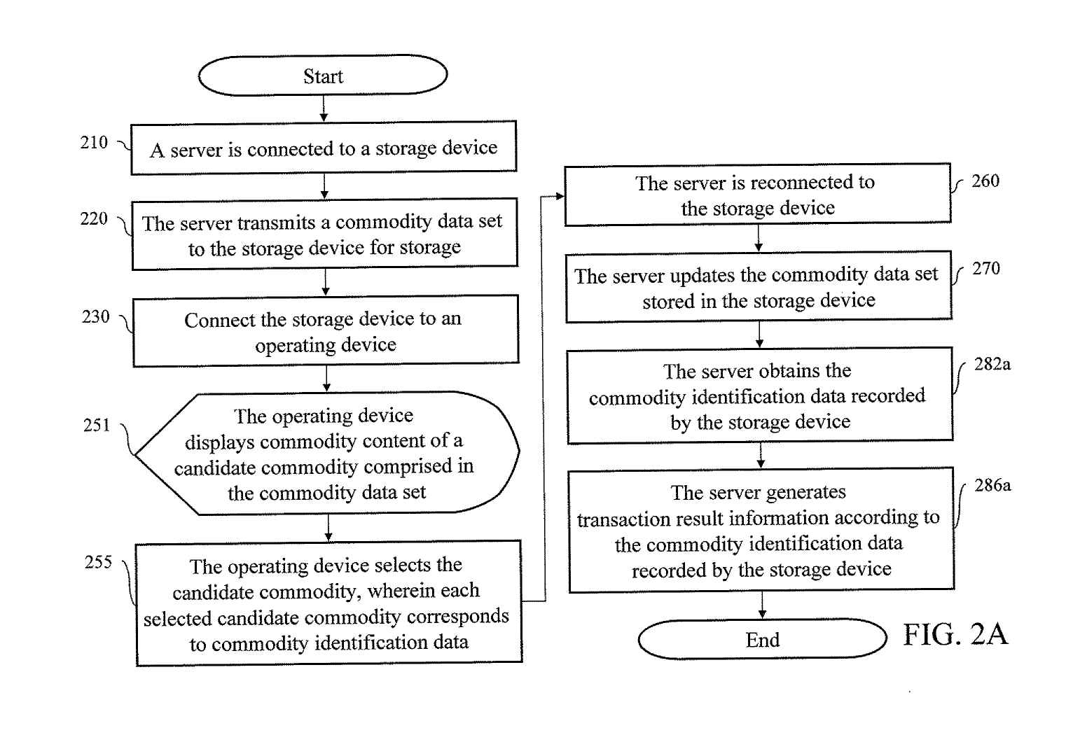

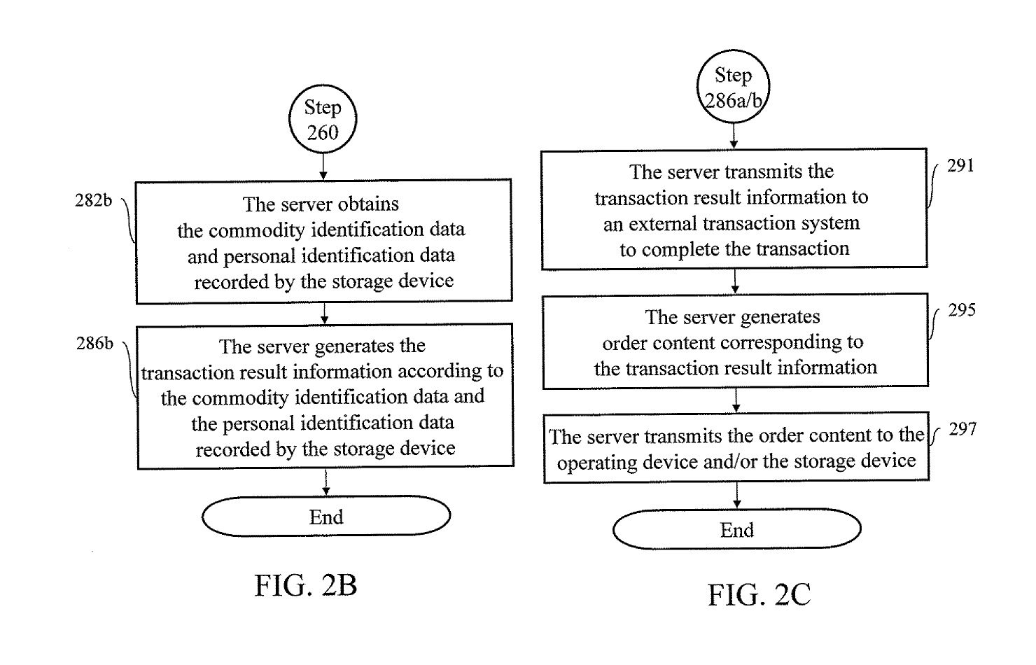

Then, an operating system and a method according to the present invention are described through an embodiment and with reference to a flowchart of a transaction method for exchanging commodity data via a portable storage device according to the present invention shown in FIG. 2A. In this embodiment, it is assumed that a storage device 110 is a tablet computer with a wireless communication module, an operating device 120 is set in a home of a user, and a server 130 is set in a school of the user, but the present invention is not limited thereto.

When the user carries the tablet computer (the storage device 110) to the school, the table computer can be connected to the server 130 (step 210). In this embodiment, it is assumed that the tablet computer is actively connected, through a wireless network technology, to the server 130.

After the tablet computer is connected to the server 130 (step 210), the server 130 can actively transmit a commodity data set to the tablet computer, so that the tablet computer receives and stores the commodity data set transmitted by the server 130 (step 220). In this embodiment, it is assumed that candidate commodities included in the commodity data set are reference books for courses learnt by the user, and commodity content of the candidate commodities is related data of the reference books, such as, a name, an amount of money, a brief introduction of the book, and a reference reason why the book is listed as a reference book.

In practice, after being connected to the tablet computer (step 210) and before transmitting the commodity data set to the tablet computer (step 220), the server 130 may identify that the storage device 110 is corresponding to information of a specific site set in advance by the server 130. In this embodiment, it is assumed that the server 130 identifies that the storage device 110 is in the school according to geographic location information of the storage device 110, whether the storage device 110 uses a network location within the school, or the storage device 110 is connected to the server 130 by using a network device set within the school. If the storage device 110 is in the school, it indicates that the user of the storage device 110 is a school person, and in this case, the server 130 transmits the commodity data set to the storage device 110.

Then, after the user leaves school and goes back home with the tablet computer, the tablet computer can be connected to an operating device 120 (step 230). In this embodiment, it is assumed that the user connects the tablet computer and the operating device 120 through a physical line; after being connected through the physical line, the tablet computer and the operating device 120 search for each other, and the one which first finds the other one actively establishes a connection with the other one.

After the tablet computer is connected to the operating device 120 (step 230), if the user intends to browse the commodity data set, the user can open a file including the commodity data set on the operating device 120; in this manner, the operating device 120 can read and display the commodity content of the candidate commodity included in the commodity data set (step 251). In this embodiment, the name, the amount of money, the brief introduction, the reference reason of each reference book, and the like, are displayed.

If the user intends to purchase one or more reference books (candidate commodities), the user can select the candidate commodities to be purchased on the operating device 120 by using input devices such as a keyboard and a mouse; in this manner, the operating device 120 can select, according to an operation of the user, a candidate commodity to be purchased by the user (step 225). In this embodiment, if it is assumed that the commodity identification data corresponding to the reference book is included in the commodity content of the reference book, the operating device 120 reads the commodity identification data of the candidate commodity from the commodity content of the candidate commodity selected by the user, for example, an international standard book number (ISBN) of the book, and writes the read commodity identification data to the storage device 110, so as to complete selection of the candidate commodity.

After the user selects the candidate commodity and again carries the tablet computer to the school, the server 130 can be actively reconnected to the tablet computer (step 260). Then, the server 130 can download the commodity identification data of the candidate commodity recorded by the tablet computer (step 282a), and generate the transaction result information according to the commodity identification data recorded by the tablet computer (step 286a). In this embodiment, the server 130 generates the order data including the selected reference book.

In the foregoing embodiment, after the server 130 is reconnected to the tablet computer (step 260), the server 130 can obtain the commodity identification data of the candidate commodity recorded by the tablet computer (step 282a) and can also transmit the commodity data set stored in the server 130 to the tablet computer to make the tablet computer download and update the stored commodity data set (step 270), so that a version of the commodity data set stored in the tablet computer is kept consistent with that on the server 130, that is, the latest version is kept.

In addition, the foregoing embodiment may be further a flow shown in FIG. 2B. After the server 130 is reconnected to the tablet computer (step 260), the server 130 can not only obtain the commodity identification data of the candidate commodity recorded by the tablet computer, but also obtain the personal identification data of the user (step 282b) and generate the transaction result information according to the commodity identification data and the personal identification data recorded by the tablet computer (step 286b). In this embodiment, it is assumed that the order generated by the server 130 includes not only transaction related data such as a name, the number, and an amount of money of the selected reference books, but also a student number (personal identification data) of the user and even includes the basic personal data such as a name, an address, and a contact manner of the user.

In addition, the foregoing embodiment may also be a flow shown in FIG. 2C after the server 130 generates the transaction result information according to the commodity identification data recorded by the tablet computer (step 286a) or generates the transaction result information according to the commodity identification data or the personal identification data recorded by the tablet computer (step 286b). The server 130 can generate order content corresponding to the transaction result information (step 295) and transmit the generated order content to the storage device 110 for storage, or transmit the order content to the operating device 120 in a form such as an e-mail or an instant message (step 297). In this embodiment, it is assumed that the order content is the commodity which is purchased, that is, the name of the reference book.

Even, after generating the transaction result information according to the commodity identification data recorded by the tablet computer (step 286a) or generating the transaction result information according to the commodity identification data or the personal identification data recorded by the tablet computer (step 286b), the server 130 may also transmit the generated transaction result information to an external transaction system (step 291), for example, a shopping system in a site where the server is set. In this manner, the user can pay and take the selected reference book at a transaction unit in the school, such as a co-operative society.

To sum up, it can be known that the difference between the present invention and the prior art lies in that in the present invention, commodity content of a candidate commodity sold on a server is stored in a portable storage device, commodity identification data of the candidate commodity selected by a user is stored after the user uses the operating device to select the candidate commodity stored in the storage device, and the server generates transaction result information according to the commodity identification data stored in the storage device, so as to solve, by using the technical means, the problem in the prior art that consumption of the user of the network transaction platform may be affected due to conditions of software and hardware management, and further achieve the technical efficacy of effectively providing the commodity to a specific group merely.

Furthermore, the transaction method for exchanging commodity data via a portable storage device of the present invention may be implemented in hardware, software, or a combination of software and hardware, or implemented in a computer system in a centralized manner, or implemented in different elements which are distributed in several interconnected computer systems in a decentralized manner.

What is claimed is:

1. A transaction method for exchanging commodity data via a portable storage device, at least comprising:
connecting a server to a storage device;
transmitting a commodity data set from the server to the storage device for storage;
connecting the storage device to an operating device;
displaying commodity content of at least one candidate commodity comprised in the commodity data set by the operating device, and selecting the at least one candidate commodity, wherein each selected candidate commodity respectively corresponds to a commodity identification data;
reconnecting the server to the storage device;
obtaining each of the commodity identification data recorded by the storage device by the server; and
generating a transaction result information by the server according to each of the commodity identification data.

2. The transaction method for exchanging commodity data via a portable storage device according to claim 1, wherein the step of connecting the server to the storage device further comprises a step of connecting the storage device after the server identified that the storage device has an information of a specific site set in advance by the server.

3. The transaction method for exchanging commodity data via a portable storage device according to claim 1, wherein after the server generates the transaction result information according to each selected commodity identification data, the transaction method further comprises a step of generating an order content corresponding to the transaction result information by the server, and transmitting the order content to the operating device and/or the storage device for storage.

4. The transaction method for exchanging commodity data via a portable storage device according to claim 1, wherein after the server generates the transaction result information according to each selected commodity identification data, the transaction method further comprises a step of transmitting the transaction result information by the server to an external transaction system to complete transaction.

5. The transaction method for exchanging commodity data via a portable storage device according to claim 1, wherein the step of obtaining each of the commodity identification data recorded by the storage device by the server further comprises a step of obtaining each of the commodity identification data and a personal identification data recorded by the storage device by the server, and the step of generating the transaction result information by the server according to each of the commodity identification data further comprises a step of generating the transaction result information by the server according to each of commodity identification data and the personal identification data.

6. The transaction method for exchanging commodity data via a portable storage device according to claim 1, wherein the method further comprises a step of updating the commodity data set stored in the storage device by the server after the reconnection from the server to the storage device.

7. A transaction system for exchanging commodity data via a portable storage device, at least comprising:
a storage device, used for storing a commodity data set, wherein the commodity data set comprises at least one candidate commodity, and each candidate commodity is corresponding to a commodity identification data respectively;
an operating device, used for displaying commodity content of each candidate commodity, and selecting the at least one candidate commodity when the operating device is connected to the storage device, so that the storage device records commodity identification data corresponding to each selected candidate commodity; and
a server, used for generating a transaction result information according to each of the commodity identification data recorded by the storage device, when the server is connected to the storage device.

8. The transaction system for exchanging commodity data via a portable storage device according to claim 7, wherein the server is further used for being connected to the storage device after identified that the storage device has information of a specific site set in advance by the server.

9. The transaction system for exchanging commodity data via a portable storage device according to claim 7, wherein the server is further used for generating an order content corresponding to the transaction result information, and the storage device and/or the operating device is further used for receiving and storing the order content.

10. The transaction system for exchanging commodity data via a portable storage device according to claim 7, wherein the server is further used for transmitting the transaction result information to an external transaction system to complete transaction.

11. The transaction system for exchanging commodity data via a portable storage device according to claim 7, wherein the storage device is further used for storing a personal identification data, and the server is further used for obtaining the personal identification information, and generating the transaction result information according to each of the commodity identification data and the personal identification data recorded by the storage device.

12. The transaction system for exchanging commodity data via a portable storage device according to claim 7, wherein the server updates the commodity data set stored in the storage device after the server reconnect to the storage device.
